(19) United States
(12) Patent Application Publication
(10) Pub. No.: US 2009/0076741 A1
(43) Pub. Date: Mar. 19, 2009

(54) DISTRIBUTED SYSTEM FOR MEASURING LUMBER IN A SAWMILL

(75) Inventor: Earl M. Barker, Enumclaw, WA (US)

Correspondence Address: JENSEN + PUNTIGAM, P.S., 2033 6th Ave, Suite 1020, SEATTLE, WA, 98121, US

(73) Assignee: EB ASSOCIATES, INC., ENUMCLAW, WA (US)

(21) Appl. No.: 11/857,656

(22) Filed: Sep. 19, 2007

(51) Int. Cl. G06F 19/00

(52) U.S. Cl. 702/33

(57) ABSTRACT

The lumber measuring system includes a pair of single point lasers for measuring cut lumber in one or more scan zones. An electrical box connected to local 110V AC power is located close to the scan zone, within a short distance of the lasers, so that conduit for connecting cables is not required. The electrical box includes a power supply providing a plurality of DC voltages, a large character display and an Ethernet to serial converter. Connectors are provided in an exterior panel of the electrical box for connecting the assemblies in the box with the local lasers and the central computer. Pre-wired cables, with MS-style connectors on both ends, are provided for connection between the lasers and the associated connectors in the enclosures, the cables being wired so there is only a single position in which the cable connectors can connect to the lasers and to the connectors on the electrical box. A computer receives data from the lasers and provides measurement information back to the display.

### TECHNICAL FIELD

This invention relates generally to measuring cut lumber in a sawmill, and more specifically concerns a distributed system for measuring lumber which can be used in a single or multiple zones in the sawmill.

### BACKGROUND OF THE INVENTION

Systems for measuring lumber produced by sawmill cutting operations are known. One such known system measures every cant and board as they are produced, monitors board size in real time, and send alarms when the boards are not within specification. This provides an automatic method for monitoring sawing accuracy, generally providing higher quality and grade yields.

FIG. 1 shows a four scan zone system using the known system referred to above. The system 10 includes four scan zones 12, 14, 16 and 18. The individual zones are typically several hundred feet apart and located throughout the sawmill facility. The system control computer 22 is centrally located, while nearby typically is a central electrical cabinet 24 which services all of the scan zones and contains a power supply and a laser concentrator which communicates with the individual lasers in each scan zone and the computer 22. However, these systems have some disadvantages, particularly in the installation thereof in a sawmill, due to the configuration of the system.

Because of the distance between the single centralized electrical cabinet 24 which services all of the scan zones, including the individual lasers in the scan zones, the connecting cable typically must be pulled through conduits which extend between the electrical cabinet and the scan zone locations. The installation of such a system usually requires a special crew and installation at off hours of the sawmill. The physical connections between the connecting cable and the lasers and the laser concentrator, respectively, must be done on-site, including soldering and other termination connections. In order to ensure correct connections, an installation team must be on-site for inspection of the system, in order to ensure safety of the components of the system, particularly the lasers, which can be easily damaged by incorrect wiring. All of the above makes installation expensive, time-consuming and labor-intensive, requiring specialized personnel from the provider of the system.

It would be desirable to have a measuring system for lumber (cut boards) which could be accurately and quickly installed by sawmill employees. Further, it would be desirable to be able to move a board measuring system from zone to zone in a sawmill.

### DISCLOSURE OF THE INVENTION

Accordingly, the present invention is a system for measuring lumber in a sawmill, comprising: a local scanning system for at least one scan zone, including: a pair of lasers for imaging cut lumber in the one zone, an electrical box containing a data display, a signal converter and a power supply, the electrical box being located within a short distance of the lasers; and electrical cables for supplying power from the power supply in the electrical box to the lasers and for transmitting data between the lasers and the signal converter, the cables having pre-wired connectors on the ends thereof for connecting to mating electrical connectors on the electrical box and the lasers; and a computer for receiving and processing data from the lasers and for transmitting results of the processing for display on the data display, wherein the system permits a plug and play installation by a user without making incorrect wiring connections within the system.

### BRIEF DESCRIPTION OF THE DRAWINGS

FIG. 1 is a block diagram of a prior art board measuring system useful in a sawmill.

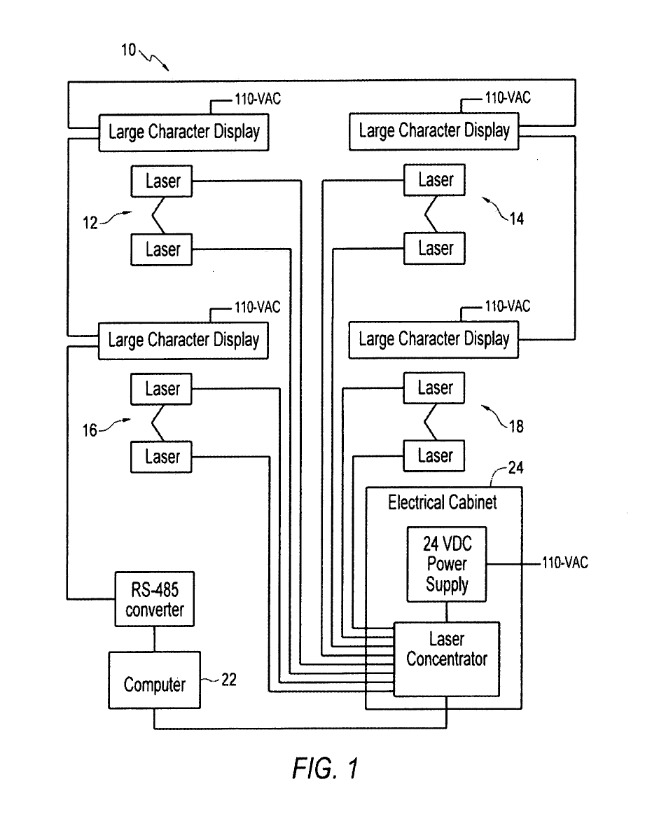

FIG. 2 is a block diagram showing the board measuring system of the present invention for one zone.

FIG. 3 is a block diagram showing the system of FIG. 2 expanded into four zones.

### BEST MODE FOR CARRYING OUT THE INVENTION

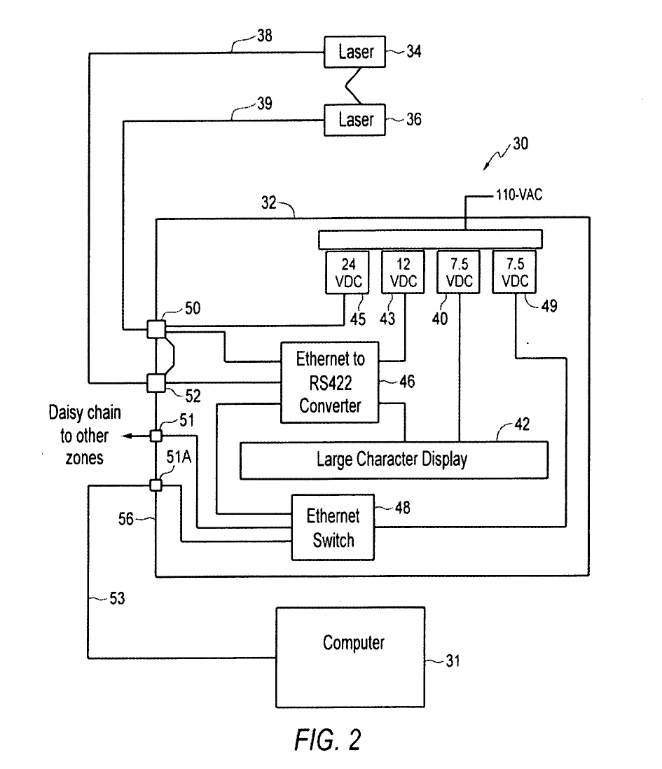

FIG. 2 shows a single scan zone board measuring system 30 described herein. The system measures each board as it is produced by the saws in the single zone in a sawmill and provides this information to a system computer 31, which analyzes the results and provides a variety of information, in various formats, including tabular data, strip charts and histograms, concerning the boards. This information can then be used to improve overall lumber quality and to produce higher yields. Typically, there will be a pair of lasers 34 and 36 in the zone for measuring the boards as they come from the saws. The lasers are single point lasers in the embodiment shown. Single point lasers are available from a variety of manufacturers. An important feature of the system 30 is that an electrical box 32 is located local to the scan zone, close enough to the lasers that electrical conduit for the connecting cables 38, 39 is not necessary. The electrical box 32 is connected locally to 110V AC power and includes four internal DC power supplies in the embodiment shown produced from the 110V AC source.

One power supply 40, 7.5VDC, is connected to a large character reader board display 42 in electrical box 32. A second power supply 43, 12 VDC, is connected to a conventional four port Ethernet to RS422 multiport converter 46, also referred to generally as a signal converter, for power and data. A third power supply 45, 24 VDC, is for lasers 34, 36. The Ethernet converter 46 connects to the large character display 42, MS-style connectors 50 and 52 for laser cables 38 and 39 and to an Ethernet switch 48, to which is also connected a fourth power supply 49, 7.5 VDC. Two ports from switch 48 are connected to external RJ45 industrial connectors 51, 51A. Connector 51A connects to computer 31 by a standard CAT5 cable 53. The other connector 51 permits connection to other electrical boxes in a multi-zone arrangement, as discussed below. The computer 31 can also be part of a network. The connectors 50, 51, 51A, 52 and 54 are all mounted in a side panel 56 of electrical box 32.

In a variation of the arrangement of FIG. 2, the Ethernet switch and the connecting cables therefrom (and the power supply 49) could be eliminated by use of wireless communication, when the four-port Ethernet converter is a wireless device.

Connecting each laser 34 and 36 to MS connectors 50 and 52 are laser cables 38 and 39. The laser cables 38 and 39 have MS connectors at both ends thereof. The connector on one end of each cable screws into an associated single point laser, while the connector on the other end of each cable connects to the MS connector mounted on panel 56 of electrical box 32. The laser cables are relatively short, typically less than 30 feet, because electrical box 32 is mounted nearby the lasers. The user is able to observe the board information produced by the lasers and the computer on reader board display 42, which, being in electrical box 32, is nearby the sawmill scan zone associated with the display. The display is typically color coded; for instance, green can be used for boards within tolerance results, red for below the lower tolerance limit and orange for above the upper tolerance limit. The connectors on the ends of the laser cables 38, 39 are mounted prior to shipment of the system to end users. The connectors on the laser cables are configured so that they fit in only one position to both the connectors on the lasers and the connectors on electrical box 32. This arrangement prevents connection errors and helps make installation of the system simple, straightforward and reliable.

The above system is convenient to install by sawmill personnel in normal course, without shutting down the mill operation, since there are no long cable runs and thus no need for conduits. Since the Ethernet cable and the laser cables are all pre-wired with connectors on both ends, there is also no chance of wiring errors by the customer in their installation of the cables to the lasers and to the connectors at the electrical box.

In installing the system, a sawmill customer will locate an electrical box locally to a selected scan zone, within a relatively short distance from the scan zone lasers, for instance, 30 feet. The cables provided with the system are then connected to the system computer and the two lasers. Software is provided in the system configuration to process the laser information and provide display/warning information to the display in each zone. The hardware in the system, including the lasers, the display unit and the Ethernet converter, may be tested at the manufacturer's facility and pre-configured for a specific customer. The system is ready to be powered-up and used immediately after installation, referred to as a plug and play system. No specialized installation/set-up team from the manufacturer is necessary and the installation can be accomplished during normal operating hours, if desired, with minimal interruption of normal sawmill operations.

The system of FIG. 2 allows a user to try the system at one location (one zone) and then expand it or move the system to another zone. Additional zones can be conveniently added to the one zone, all connecting to a central computer, as discussed below.

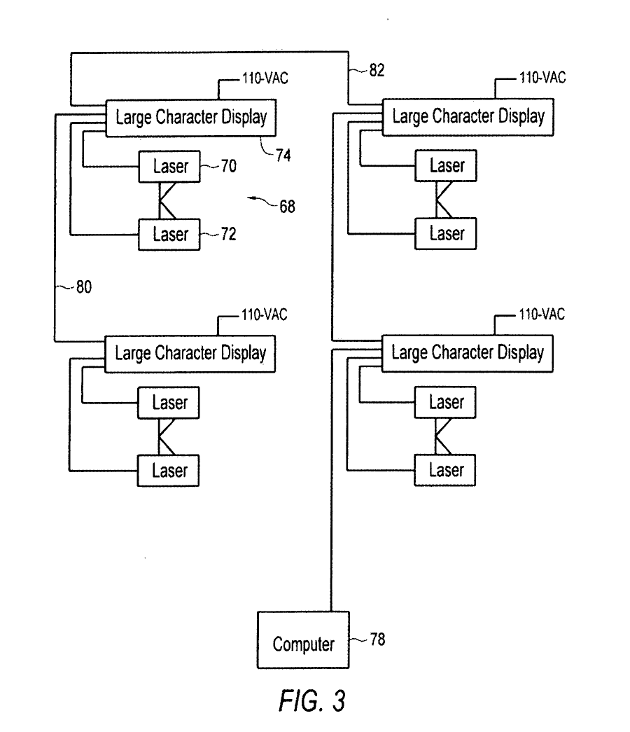

FIG. 3 shows a multi-zone system, specifically four scan zone locations, in a sawmill, with the system incorporating the principles of the present invention, specifically the use of localized electrical boxes, each with a display associated with a single scan zone as well as power supplies and a laser concentrator for the scan zone. Each scan zone (scan zone 68 is exemplary) includes two lasers 70, 72 and a nearby electrical enclosure box 74 with the required power supplies therein (not shown) and a large character display 74. The electrical boxes are all connected to the central computer 78. The electrical boxes in the four zones can be connected in a “daisy chain” arrangement, from zone to zone, using the Ethernet switch in each electrical box and connecting cables, such as cables 80 and 82, from a previous electrical box and to a successive electrical box, respectively. Each display shows the size of the resulting boards for each zone in real time as they are produced. Each zone is self-contained and is connected to the central computer 78 via Ethernet. Alternatively, as indicated above, wireless communication can be used, eliminating the Ethernet switch and related cables. Although a four-zone system is shown in FIG. 3, it should be understood that different numbers of scan zones can be used, with the electrical box at each zone being connected to the central computer.

Hence a lumber measuring system has been described which has the advantage of simple, low-cost installation, not requiring specialized installation personnel. The customer is able to take the system as delivered and conveniently install it, without risk of incorrect wiring or system connection, thus saving expense and the time of the system provider.

Although the above system utilizing local enclosures/boxes with power supplies and other elements connecting to lasers is described for measuring boards in the context of a sawmill application, it should be understood that the principles of the above system can be used in other industries and applications for monitoring of various manufactured items.

Although a preferred embodiment of the invention has been disclosed for purposes of illustration, it should be understood that various changes, modifications and substitutions may be incorporated in the invention without departing from the spirit of the invention which is defined by the claims that follow.

What is claimed is:

1. A system for measuring lumber in a sawmill, comprising:
a local scanning system for at least one scan zone, including: a pair of lasers for imaging cut lumber in the one zone, an electrical box containing a data display, a signal converter and a power supply, the electrical box being located within a short distance of the lasers; and electrical cables for supplying power from the power supply in the electrical box to the lasers and for transmitting data between the lasers and the signal converter, the cables having pre-wired connectors on the ends thereof for connecting to mating electrical connectors on the electrical box and the lasers; and
a computer for receiving and processing data from the lasers and for transmitting results of the processing for display on the data display, wherein the system permits a plug and play installation by a user without making incorrect wiring connections within the system.

2. The system of claim 1, including a plurality of local scanning systems, each associated with a selected scan zone in the sawmill and connected to the computer in a daisy chain configuration.

3. The system of claim 1, wherein communication between the computer, the lasers and the display is by Ethernet.

4. The system of claim 2, wherein communication between the computer and the lasers and display in each local scanning system is by Ethernet.

5. The system of claim 1, wherein the signal converter is an Ethernet to serial converter.

6. The system of claim 1, wherein the electrical box is connected to local 110 volt AC power, and wherein the electrical box includes separate DC power supplies for the data display, the signal converter and the lasers.

7. The system of claim 1, wherein data is transmitted to and from the computer by cable connections.

8. The system of claim 1, wherein data is transmitted to and from the computer by wireless connection.

9. The system of claim 2, wherein data is transmitted to and from the computer by cable connections.

10. The system of claim 2, wherein data is transmitted to and from the computer by wireless connections.

11. A system for measuring dimensions of articles after production/manufacture thereof, comprising:
a local scanning system for at least one zone of production, including: a pair of lasers for imaging the articles from the one zone, an electrical box containing a data display, a signal converter and a power supply, the electrical box being located within a short distance of the lasers; and electrical cables for supplying power from the power supply in the electrical box to the lasers and for transmitting data between the lasers and the signal converter, the cables having pre-wired connectors on the ends thereof for connecting to mating electrical connectors on the electrical box and the lasers; and
a computer for receiving and processing data from the lasers and for transmitting results of the processing for display on the data display, wherein the system permits a plug and play installation by a user without making incorrect wiring connections within the system.

12. The system of claim 11, including a plurality of local scanning systems, each associated with a selected scan zone and connected to the computer in a daisy chain configuration.

13. The system of claim 11, wherein communication between the computer, the lasers and the display is by Ethernet.

14. The system of claim 12, wherein communication between the computer and the lasers and display in each local scanning system is by Ethernet.

15. The system of claim 11, wherein data is transmitted to and from the computer by cable connections.

16. The system of claim 11, wherein data is transmitted to and from the computer by wireless connection.

17. The system of claim 12, wherein data is transmitted to and from the computer by cable connections.

18. The system of claim 12, wherein data is transmitted to and from the computer by wireless connections.
